(19) United States
(12) Patent Application Publication
(10) Pub. No.: US 2008/0145046 A1
(43) Pub. Date: Jun. 19, 2008

(54) Camera with orienting function

(76) Inventor: Chin-Hsin Ho, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/743,194

(22) Filed: May 2, 2007

(30) Foreign Application Priority Data
Dec. 18, 2006 (TW) 095147543

(51) Int. Cl. G03B 17/00

(52) U.S. Cl. 396/428

(57) ABSTRACT

A camera with orienting function comprising a main part and an orienting part is disclosed. The orienting part is connected with the main part, and the orienting part is operated under an open state or a close state. When the orienting part is under the open state, at least a portion of the orienting part protrudes out of the main part.

### BACKGROUND OF THE INVENTION

1. Field of the Invention

The present invention relates to a camera and, more particularly, the invention relates to a camera with orienting function.

2. Description of the Related Art

The camera is usually provided with the function of marco mode in the prior art. The least distance of the marco mode is different among various brands or models. When using the function of marco mode, the user often wants to take the biggest and clearest image of the object.

When changing into the function of marco mode, the camera can't take the biggest image if the distance between the camera and the object is greater than the least distance designed for the camera. If the distance between the camera and the object is less than the least distance designed for the camera, the camera can't focus on the object adequately, therefore making the taken image unclear. In order to capture the biggest image, the user should maintain a distance between the camera and the object within the designed least distance of the camera. However, the prior art of the camera can't keep this distance accurately. The only way is for the user to roughly estimate, not being able to know the exact distance when taking images.

Moreover, when the camera is in the function of marco mode, a tiny shock is sufficient to make the image blur even when in the designed range of least distance. This is because of the shallow depth of field in the marco function. For instance, the camera which is held by the user can easily cause poor image quality due to the shock from hand movements.

Therefore, it is necessary to be provided a camera with orienting and supporting function to solve the previous problem in the prior art.

### SUMMARY OF THE INVENTION

The object of the present invention is to provide a camera with distance orienting when taking images in the marco mode.

Another objective of the present invention is to provide a camera with supporting function in the marco mode.

In order to achieve the above-mentioned objective, the invention of camera with orienting function comprising a main part and an orienting part is disclosed. Wherein the orienting part is connected with the main part, and the orienting part is operated under an open state or a close state. When the orienting part is under the open state, at least a portion of the orienting part protrudes out of the main part.

According to one embodiment of the invention, the camera comprises a switch element, and the orienting part comprises a first elastomer. When turning on the switch element, the first elastomer can release it's elasticity to make the orienting part protrude out of the main part in revolving way.

According to another embodiment of the invention, the orienting part comprises a ruler which can be curved; the camera comprises a fastener which can fix the location of the ruler, and a third elastomer. The third elastomer provides the ruler the necessary force from the open state back to the close state.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the first embodiment of the present invention.

FIG. 2 is a perspective view of the first embodiment under the close state of the present invention.

FIG. 3 is a perspective view of the first embodiment under the open state of the present invention.

FIG. 4 is a schematic drawing of the first embodiment when using the present invention.

FIG. 5 is a perspective view of the second embodiment under the close state of the present invention.

FIG. 6 is a perspective view of the second embodiment under the open state of the present invention.

FIG. 7 is a schematic drawing of the second embodiment when using the present invention.

FIG. 8 is a schematic drawing of the third elastomer of the torsional spring.

### DETAILED DESCRIPTION OF THE PREFERRED EMBODIMENT

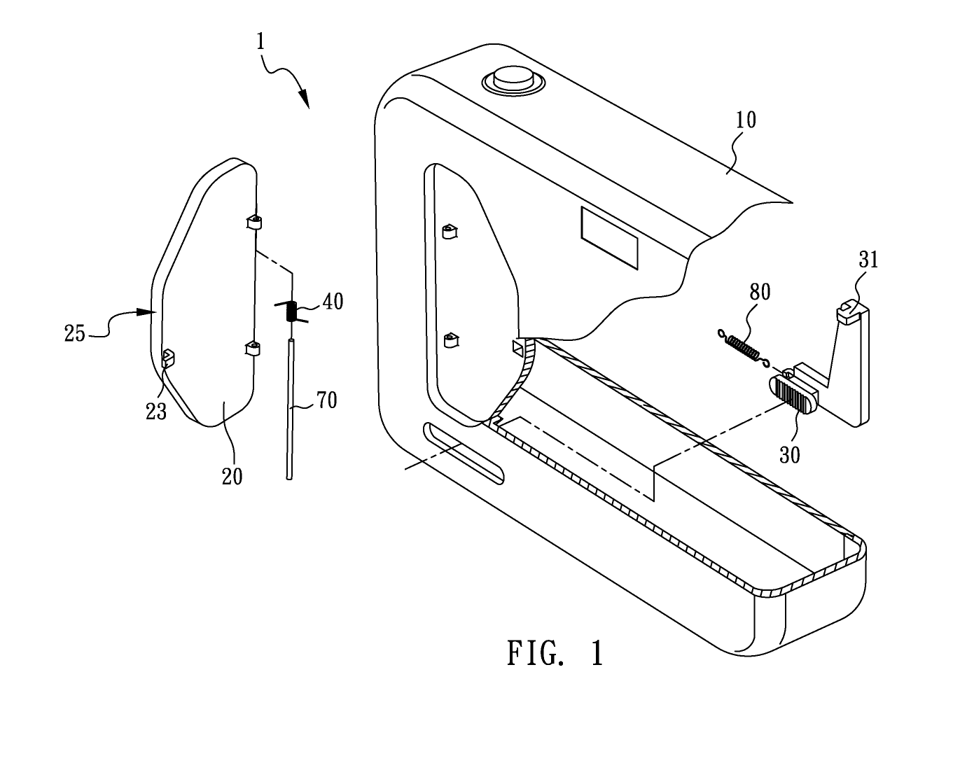

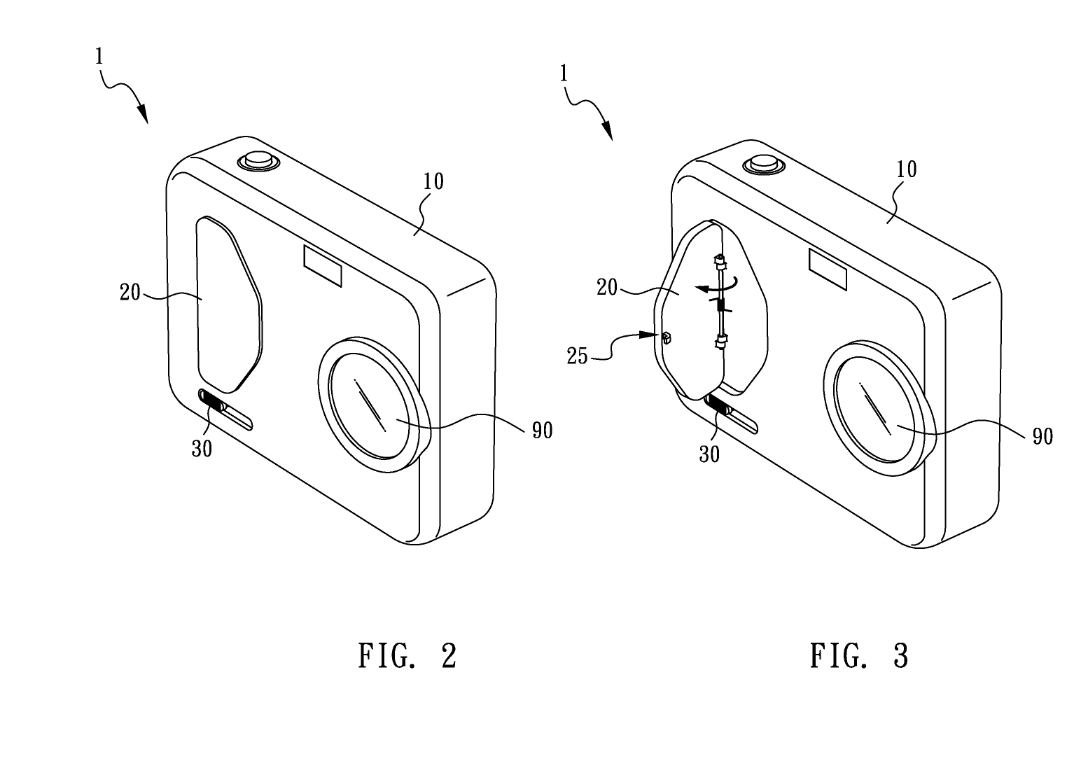

Please refer to FIG. 1 to FIG. 3 about the first embodiment of the camera with orienting function. FIG. 1 is a schematic drawing of the first embodiment of the present invention. FIG. 2 is a perspective view of the first embodiment under the close state of the present invention. FIG. 3 is a perspective view of the first embodiment under the open state of the present invention.

Please refer to FIG. 1 first. The invention of the camera with orienting function 1 comprises a main part 10, an orienting part 20, a first elastomer 40, a switch element 30, a second elastomer 80, and a lens 90. Wherein the switch element 30 and the lens 90 are both mounted in the main part 10.

The orienting part 20 is a thin object which is connected with the main part 10. Because the purpose of the orienting part 20 is to keep the distance of the lens 90 (Please refer to FIG. 2 simultaneously) and an object at a constant distance the orienting part 20 and the lens 90 are mounted in the same side of the main part 10. The orienting part 20 and the main part 10 can be revolved with each other, and the orienting part 20 is operated under an open state or a close state.

Please refer to FIG. 2. When the camera 1 is not used or not using the function of marco mode of the camera 1, the orienting part 20 and the main part 10 are not revolved with each other, i.e. the orienting part 20 is not protruded out of the main part 10. The orienting part 20 and the main part 10 are in the same level. This setting is under the close state.

Then, please refer to FIG. 3. When under the open state, the orienting part 20 and the main part 10 are revolved with each other, i.e. the orienting part 20 is protruded out of the main part 10. The orienting part 20 is designed for the function of marco mode of the camera 1. When the orienting part 20 is under the open state, the distance that the orienting part 20 protrudes out of the main part 10 is just the least distance in the marco mode of the camera 1.

Please go back to FIG. 1. The first elastomer 40 is to provide the necessary force for the orienting part 20 to protrude out of the main part 10. For instance, the first elastomer 40 is a torsional spring. The first elastomer 40 is fixed in the first revolving shaft 70, and the first revolving shaft 70 is fixed in the main part 10. By the first revolving shaft 70, the main part 10 connects with the orienting part 20, and the main part 10 and the orienting part 20 can be revolved with each other. Because a first hook 23 of the orienting part 20 and the second hook 31 of the switch element 30 are match hooks with each other in this embodiment of the invention, the first hook 23 is grappled with the second hook 31 under the close state. The first elastomer 40 is forced to change shape storing the elasticity at this time. When turning on the switch element 30, the second hook 31 departs from the position of grappling with each other. The first elastomer 40 can release its elasticity, and the orienting part 20 protrudes out of the main part 10 in revolving way.

After turning on the switch element 30, the second elastomer 80 which is mounted in the switch element 30 provides the force for the switch element 30 to go back to the position before turning on the switch element 30. In this embodiment of the invention, the second elastomer 80 is a spring. It is important to take note that when turning on the switch element 30 not only does it make the orienting part 20 revolving into the open state, but also switches on the marco mode to make the operation more convenient.

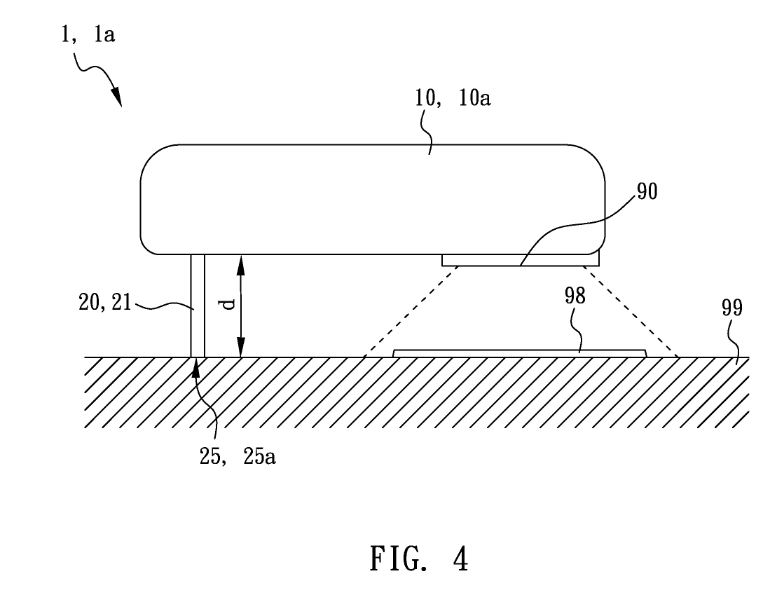

Below illustrates the order of the operation when using the function of moarco mode of the camera 1. Please go back to FIG. 2; the orienting part 20 is under the close state in this moment. When the user wants to take the biggest and clearest image, turning on the switch element 30 first to make the orienting part 20 turned over (refer the arrow of FIG. 3), and protruded out of the main part 10 to be the open state. Then please refer to FIG. 4 which is a schematic drawing of the first embodiment when using the present invention. A contact part 25 of the orienting part 20 leans against a withstanding object 99. At present, the protruding length of the orienting part 20 is the least distance d of the function of marco mode. The distance d differs from the design of the camera 1 itself. With this distance, it makes nearly the same distance between the main part 10 and the object 98 on the withstanding object 99. Besides, by the contact part 25 leaning against a withstanding object 99, it makes the camera I reduce the amount of the shock to help to obtain a clearer image. When the user wants to make the orienting part 20 go back into the close state, the only way to do is to pull back the orienting part 20 in rotating way until the first hook 23 grapples with the second hook 31, and then turning into the close state.

It is important to note that the position of the orienting part 20 which connects with the main part 10 is not limited. However, in order to ensure the function of marco mode in the position of the open state, the contact part 25 of the orienting part 20 leaning against the withstanding object 99 is better located near to the lens 90.

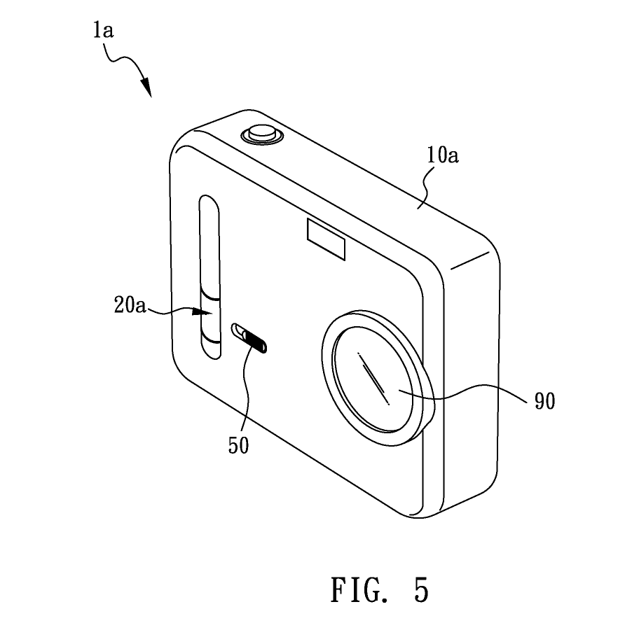

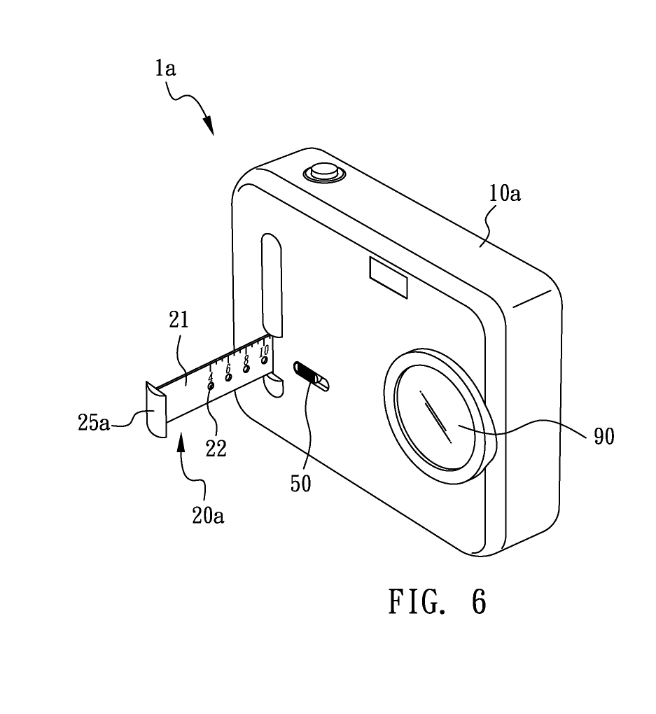

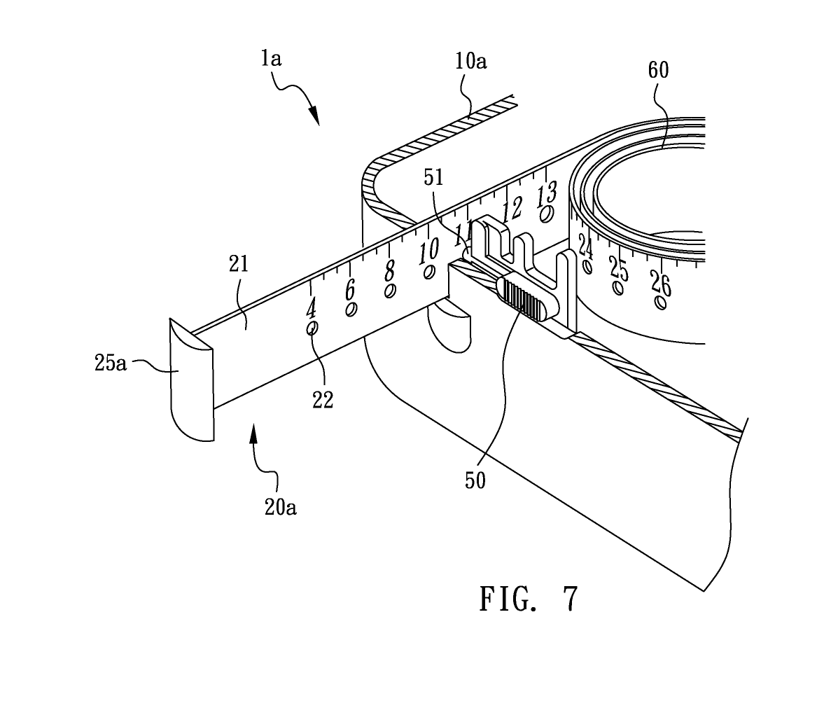

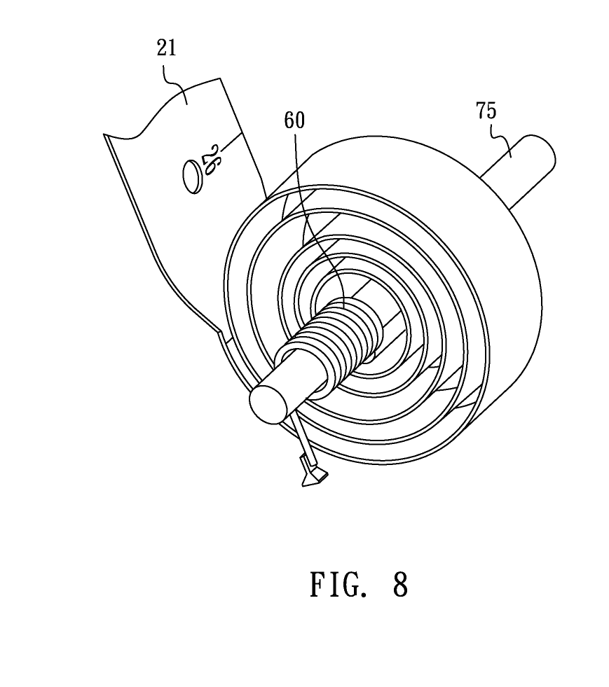

Please refer to FIG. 5 to FIG. 7 for the second embodiment of the camera with orienting function. FIG. 5 is a perspective view of the second embodiment under the close state of the present invention. FIG. 6 is a perspective view of the second embodiment under the open state of the present invention. FIG. 7 is a schematic drawing of the second embodiment when using the present invention. FIG. 8 is a schematic drawing of the third elastomer of torsional spring.

Please refer to FIG. 7. The invention of the camera with orienting function 1a comprises a main part 10a, an orienting part 20a, a third elastomer 60, a fastener 50, and a lens 90. Wherein, the orienting part 20a and the lens 90 are mounted in the same side of the main part 10a.

The orienting part 20a comprises a ruler 21 which can be curved, and the third elastomer 60. For instance, the material of the ruler 21 is the sheet iron. The user can pull out the ruler 21 from the main part 10a. The orienting part 20a is operated under an open state or a close state. When the orienting part 20a is operated under the open state, at least a portion of the ruler 21 protrudes out of the main part 10a.

Please refer to FIG. 5. When the camera 1a is not used or not using the function of marco mode of the camera 1a, the ruler 21 of the orienting part 20a is fully stored in the main part 10, i.e. the orienting part 20a is not protruded out of the main part 10. This moment is under the close state.

Please refer to FIG. 6. When under the open state, the ruler 21 of the orienting part 20a protrudes out of the main part 10a, i.e. the orienting part 20a is protruded out of the main part 10a. When the orienting part 20a is under the open state, the distance that the orienting part 20a protrudes out of the main part 10a is the distance in the marco mode of the camera 1a.

Please refer to FIG. 7. The third elastomer 60 provides the force necessary to go from the open state to the close state of the ruler 21. The third elastomer 60 is a spring leaf or a torsional spring. When the third elastomer 60 is a spring leaf (shown in FIG. 7), the end of the ruler 21 is linked together with the third elastomer 60. The structure of the orienting part 20a is similar to a measuring tape in this case. When the third elastomer 60 is a torsional spring (shown in FIG. 8), the end of the ruler 21 is linked together with the second revolving shaft 75, and the third elastomer 60 is fixed in the second revolving shaft 75, and the second revolving shaft 75 is fixed in the main part 10a.

The fastener 50 can touch the ruler 21, and it can resist the force of the third elastomer 60 to fix the location of the ruler 21. In this embodiment, the ruler 21 comprises a plurality of orienting hole 22, and the fastener 50 comprises a protruding part 51. The protruding part 51 matches the orienting hole 22 with each other. When conducting the fastener 50, the protruding part 51 and the orienting hole 22 wedge with each other to achieve the purpose of orienting the ruler 21. Wherein the first orienting hole 22 (shown in the position of scale of 4 in FIG. 7) should be the smallest distance of taking pictures of the camera 1a.

It is important to note that the ruler 21 can not comprise the orienting hole 22, and the fastener 50 can not comprise a protruding part 51. In this situation, it is directly fixed by the frictional force produced between the fastener 50 and the ruler 21 when contacting with each other.

Below illustrates the order of the operation when using the function of marco mode of the camera 1a. Please refer to FIG. 5; the orienting part 20a is under the close state in this moment. When the user wants to take the biggest and clearest image, pulling out the ruler 21 from the main part 10a first to be the open state (refer FIG. 6). The length that the ruler 21 pulls out matches the marco length of the camera 1a. Because of the scale of the ruler 21, it is easy to control the distance that the ruler 21 protrudes out of the camera 1a. Then please refer to FIG. 7. Conduct the fastener 50 to make the ruler 21 fixed in the proper position. Then please refer FIG. 4. The contact part 25a of the orienting part 20a leans against a withstanding object 99. At present, the ruler 21 makes the distance d between the main part 10a and the withstanding object 99. The distance d does not only adjust the length to the smallest marco mode, but also other lengths of marco mode. Besides, by the contact part 25a leaning against a withstanding object 99 makes the camera 1a reduce the amount of vibration to help obtain clearer image. When the user wants the camera back to the close state, the only way to do is to pull the fastener 50 back to make the ruler 21 and the fastener 50 separated. Use the elasticity force of the third elastomer 60 to make the ruler 21 roll up to the close state. The ruler 21 does not only fixes the marco distance, but also used for measuring length alone.

Although the present invention has been explained in relation to its preferred embodiment, it is to be understood that many other possible modifications and variations can be made without departing from the spirit and scope of the invention as hereinafter claimed.

What is claimed is:

1. A camera with orienting function comprising:
a main part, and
an orienting part is disclosed;
wherein the orienting part is connected with the main part, and the orienting part is operated under an open state or a close state; when the orienting part is operated under the open state, at least a portion of the orienting part protrudes out of the main part.

2. The camera with orienting function as claimed in claim 1, wherein the camera further comprises a lens which is mounted in the main part, and the orienting part and the lens are mounted in the same side of the main part.

3. The camera with orienting function as claimed in claim 1, wherein the orienting part protrudes out of the main part in revolving way.

4. The camera with orienting function as claimed in claim 3, wherein the orienting part further comprises a first elastomer; the first elastomer provides the force for the orienting part to protrude out of the main part.

5. The camera with orienting function as claimed in claim 4, wherein the first elastomer is a torsional spring.

6. The camera with orienting function as claimed in claim 5, wherein the first elastomer is fixed in the first revolving shaft, and the first revolving shaft is fixed in the main part.

7. The camera with orienting function as claimed in claim 4, wherein the camera further comprises a switch element which is mounted in the main part; when turning on the switch element, the first elastomer can release it's elasticity to make the orienting part protrude out of the main part in revolving way.

8. The camera with orienting function as claimed in claim 7, wherein the camera further comprises a second elastomer which is mounted in the switch element; the switch element is grappled with the orienting part under the close state.

9. The camera with orienting function as claimed in claim 8, wherein the second elastomer is a spring.

10. The camera with orienting function as claimed in claim 1, wherein the orienting part comprises a ruler which can be curved.

11. The camera with orienting function as claimed in claim 10, when the orienting part is operated under the open state, at least a portion of the ruler protrudes out of the main part.

12. The camera with orienting function as claimed in claim 11, wherein the camera further comprises a fastener which can fix the location of the ruler.

13. The camera with orienting function as claimed in claim 12, wherein the ruler further comprises a plurality of orienting hole, and the fastener comprises a protruding part; the protruding part matches the orienting hole with each other; when conducting the fastener, the protruding part and the orienting hole wedge with each other.

14. The camera with orienting function as claimed in claim 11, wherein the orienting part further comprises a third elastomer, and the third elastomer provides the force necessary to go from the open state to the close state of the ruler.

15. The camera with orienting function as claimed in claim 14, wherein the third elastomer is fixed in the second revolving shaft, and the second revolving shaft is fixed in the main part.

16. The camera with orienting function as claimed in claim 14, wherein the third elastomer is a spring leaf or a torsional spring.

17. The camera with orienting function as claimed in claim 1, wherein the distance that the orienting part protrudes out of the main part is the distance in the marco mode of the camera.
